(19) United States
(12) Patent Application Publication
(10) Pub. No.: US 2003/0077466 A1
(43) Pub. Date: Apr. 24, 2003

(54) Multilayered polymer structure

(76) Inventors: Sidney T. Smith, Lake Forest, IL (US); Larry A. Rosenbaum, Gurnee, IL (US); Steven Giovanetto, Vernon Hills, IL (US); Gregg Nebgen, Burlington, WI (US)

Correspondence Address: MARK J. BUONAIUTO, ESQ., BAXTER INTERNATIONAL INC., LAW DEPARTMENT, ONE BAXTER PARKWAY, DF2-2E, DEERFIELD, IL, 60015, US

(21) Appl. No.: 10/044,636

(22) Filed: Oct. 19, 2001

(51) Int. Cl. B32B 27/08

(52) U.S. Cl. 428/474.4; 428/480

(57) ABSTRACT

The present invention provides a multiple-layer structure for fabricating medical products. The multiple-layered structure has a first layer of a polyester; a second layer attached to the first layer, the second layer of an ethylene and α-olefin copolymer; and wherein the structure has a modulus of elasticity of less than about 60,000 psi.

### CROSS-REFERENCE TO RELATED APPLICATIONS

Not Applicable.

### FEDERALLY SPONSORED RESEARCH OR DEVELOPMENT:

Not Applicable.

### BACKGROUND OF THE INVENTION

1. Technical Field

The present invention relates generally to multilayered polymeric structures for fabricating tank liners and more specifically three-layered structures.

2. Background Prior Art There is an ever increasing demand for flexible polymeric containers for the medical field and related industries. Flexible polymeric containers are commonly used to contain, store and deliver therapeutic agents such as intravenous solutions, renal solutions and blood and blood products. There is also great demand for polymeric containers and tank liners for preparing bioengineered products such as recombinant proteins.

In the cell culture and biopharmaceutical industries liquids such as cell culture media, harvest material, water for injection, waste liquids, and the like must be processed, transported and stored in a sterile environment. Preparing bioengineered products, in many instances, require the processing of large volumes of fluid. It is common for such purposes to use large-volume tanks and drums for containing components prior to cell culture, to serve as mixing and reaction vessels, for storing of harvest and waste fluids and the like. These tanks and drums are usually stainless steel or plastic and must be sterile for use. After use the containers must be cleaned, sterilized and certified for use in a subsequent process.

To avoid the loss of time and cost associated with these processes, sterile polymeric tank liners have been employed with satisfactory results. Tank liners are inserted into tanks or drums and form a solution contact surface. After use these tank liners are removed from the tank and discarded and the tank is again, immediately ready for re-use. This saves significant time and expense.

In addition to tank liners, large volume 2-D and 3-D containers have been employed to store and mix fluids for bioprocessing applications. Such containers can be dimensioned from small volumes such as 1 liter to large volumes such as in excess of 1000 liters. Sterile, polymeric containers have been suitable for such applications. One such 3-D container is disclosed in commonly assigned U.S. patent Ser. No. 09/813,351, which is incorporated herein by reference.

There are numerous manufacturers of tank liners, 2-D containers and 3-D containers. One such manufacturer is Stedim. Stedim sells tank liners made from a two-layered film having a solution contact layer of a very low density polyethylene with an outer layer of nylon.

These and other aspects and attributes of the present invention will be discussed with reference to the following drawings and accompanying specification.

### SUMMARY OF THE INVENTION

The present invention provides a multiple-layer structure for fabricating medical products. The multiple-layered structure has a first layer of a polyester; a second layer attached to the first layer, the second layer of an ethylene and a-olefin copolymer; and wherein the structure has a modulus of elasticity of less than about 60,000 psi.

### BRIEF DESCRIPTION OF THE DRAWING

FIG. 1 shows a cross-sectional view of a three-layered film structure of the present invention.

### DETAILED DESCRIPTION OF THE INVENTION

While this invention is susceptible of embodiments in many different forms, and will herein be described in detail, preferred embodiments of the invention are disclosed with the understanding that the present disclosure is to be considered as exemplifications of the principles of the invention and are not intended to limit the broad aspects of the invention to the embodiments illustrated.

According to the present invention, multiple layered film structures are provided which meet the requirements set forth above. The present invention further provides a method for providing such films.

I. The Films

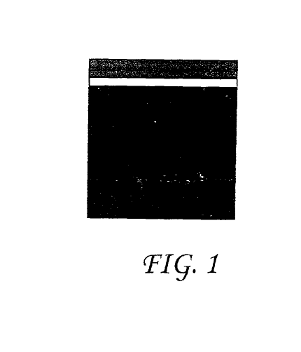

FIG. 1 shows a three-layered film structure 10 having an outer layer 12, a tie layer 14, an inner or solution contact layer 16. The outer layer 12 provides scratch resistance, ductility and tensile strength to the film structure. In a preferred form of the invention the outer layer 12 will be of a polyester or a polyamide.

Suitable polyesters for the outer layer 12 include polycondensation products of di- or polycarboxylic acids and di or poly hydroxy alcohols or alkylene oxides. In a preferred form of the invention the polyester is a polyester ether. Suitable polyester ethers are obtained from reacting 1,4 cyclohexane dimethanol, 1,4 cyclohexane dicarboxylic acid and polytetramethylene glycol ether and shall be referred to generally as PCCE. Suitable PCCE's are sold by Eastman under the tradename ECDEL.

Acceptable polyamides include those that result from a ring-opening reaction of lactams having from 4-12 carbons. This group of polyamides therefore includes nylon 6, nylon 10 and nylon 12. Most preferably, the outer layer is a nylon 12.

Acceptable polyamides also include aliphatic polyamides resulting from the condensation reaction of di-amines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers. Thus, suitable aliphatic polyamides include, for example, nylon 6,6, nylon 6,10 and dimer fatty acid polyamides.

The inner layer is preferably selected from homopolymers and copolymers of polyolefins. Suitable polyolefins are selected from the group consisting of homopolymers and copolymers of alpha-olefins containing from 2 to about 20 carbon atoms, and more preferably from 2 to about 10 carbons. Most preferably, the inner layer is selected from ethylene α-olefin copolymers especially where the a-olefin has from about 4 to about 8 carbons. Such copolymers which are commonly referred to as ultra-low density polyethylenes (ULDPE) and have a density of less than about 0.905 g/cc, more preferably less than about 0.900 g/cc and most preferably less than about 0.895 g/cc. Preferably the ethylene α-olefin copolymers are produced using a single site catalyst such as a metallocene catalyst. Such catalysts are said to be “single site” catalysts because they have a single, sterically and electronically equivalent catalyst position as opposed to the Ziegler-Natta type catalysts which are known to have a mixture of catalysts sites. Such metallocene catalyzed ethylene α-olefins are sold by Dow under the tradename AFFINITY, and by Exxon under the tradename EXACT.

Suitable tie layers include modified polyolefins blended with unmodified polyolefins. The modified polyolefins are typically polyethylene or polyethylene copolymers. The polyethylenes can be ULDPE, low density (LDPE), linear low density (LLDPE), medium density polyethylene (MDPE), and high density polyethylenes (HDPE). The modified polyethylenes may have a density from 0.850-0.95 g/cc.

The polyethylene may be modified by grafting with carboxylic acids, and carboxylic anhydrides. Suitable grafting monomers include, for example, maleic acid, fumaric acid, itaconic acid, citraconic acid, allylsuccinic acid, cyclohex-4-ene-1,2-dicarboxylic acid, 4-methylcyclohex-4-ene-1,2-dicarboxylic acid, bicyclo[2.2.1]hept-5-ene-2,3-dicarboxylic acid, x-methylbicyclo[2.2.1]hept-5-ene-2,3-dicarboxylic acid, maleic anhydride, itaconic anhydride, citraconic anhyride, allylsuccinic anhydride, citraconic anhydride, allylsuccinic anhydride, cyclohex-4-ene-1,2-dicarboxylic anhydride, 4-methylcyclohex-4-ene-1,2-dicarboxylic anhydride, bicyclo[2.2.1] hept-5-ene2,3-dicarboxylic anhydride, and x-methylbicyclo[2.2.1] hept-5-ene-2,2-dicarboxylic anhydride.

Examples of other grafting monomers include C₁-C₈ alkyl esters or glycidyl ester derivatives of unsaturated carboxylic acids such as methyl acrylate, methyl methacrylate, ethyl acrylate, ethyl methacrylate, butyl acrylate, butyl methacrylate, glycidyl acrylate, glycidal methacrylate, monoethyl maleate, diethyl maleate, monomethyl maleate, diethyl maleate, monomethyl fumarate, dimethyl fumarate, monomethyl itaconate, and diethylitaconate; amide derivatives of unsaturated carboxylic acids such as acrylamide, methacrylamide, maleicmonoamide, maleic diamide, maleic N-monoethylamide, maleic N,N-dietylamide, maleic N-monobutylamide, maleic N,N dibutylamide, fumaric monoamide, fumaric diamide, fumaric N-monoethylamide, fumaric N,N-diethylamide, fumaric N-monobutylamide and fumaric N,N-dibutylamide; imide derivatives of unsaturated carboxylic acids such as maleimide, N-butymaleimide and N-phenylmaleimide; and metal salts of unsaturated carboxylic acids such as sodium acrylate, sodium methacrylate, potassium acrylate and potassium methacrylate. More preferably, the polyolefin is modified by a fused ring carboxylic anhydride and most preferably a maleic anhydride.

The unmodified polyolefins can be selected from the group consisting of ULDPE, LLDPE, MDPE, HDPE and polyethylene copolymers with vinyl acetate and acrylic acid. Suitable modified polyolefin blends are sold, for example, by DuPont under the tradename BYNEL®, by Chemplex Company under the tradename PLEXAR®, and by Quantum Chemical Co. under the tradename PREXAR.

The relative thicknesses of the layers of the structure 10 are as follows: the outer layer should have a thickness from about 0.5 mil to about 4.0 mil, more preferably from about 0.5 mils to about 2.0 mils or any range or combination of ranges therein. The inner layer preferably has a thickness from about 4.0 mils to about 12.0 mils and more preferably from about 6 mils to about 10 mils, or any range or combination of ranges therein. The tie layer preferably has a thickness from about 0.2 mils to about 2.0 mils, more preferably from about 0.5 mils to about 1.0 mil or any range or combination of ranges therein. Thus, the overall thickness of the layered structure will be from about 5.0 mils to about 18 mils.

The layered structures of the present invention are well suited for fabricating tank liners as they deploy in a supporting tank with a minimum of wrinkles and, can withstand from about 0.5 psi to about 5 psi of pressure while unsupported by a tank without bursting and can withstand from about 5 psi to about 10 psi and more preferably from about 7 psi to about 10 psi, while supported in a tank, without bursting. The layered structure can also be fabricated into a fluid container which can be filled with sterile water and withstand multiple drops without bursting. In a preferred form of the invention, the layered structure can be fabricated into a 6 liter fluid container filled with sterile water can withstand multiple eight foot drops without bursting.

II. The Methods

The above layers may be processed into a layered structure by standard techniques well known to those of ordinary skill in the art and including coextrusion, cast coextrusion, extrusion coating, or other acceptable process. Preferably, the layered structure is fabricated into films using a cast coextrusion process. The process should be essentially free of slip agents and other low molecular weight additives that may increase the extractables to an unacceptable level.

In a preferred form of the invention, the method includes the steps of: (1) providing a PCCE material as described above; (2) providing an ethylene and α-olefin copolymer having a density of less than about 0.900 g/cc as described above; (3) providing a tie material as described above; (4) coextruding the PCCE material, the ethylene and α-olefin copolymer and the tie layer to define a multilayered structure having a first layer of PCCE, a second layer of ethylene and α-olefin copolymer and a tie layer attaching the first layer to the second layer; and (5) wherein the step of coextruding is carried essentially free of slip agents. The method further includes the steps of preparing the films having the layer thicknesses and overall film thicknesses set forth above.

An illustrative, non-limiting example of the present multilayered structures is set out below. Numerous other examples can readily be envisioned in light of the guiding principles and teachings contained herein. The example given herein is intended to illustrate the invention and not in any sense to limit the manner in which the invention can be practiced.

### III. THE EXAMPLES

A three-layered structure was coextruded in accordance with the teachings of the present invention. The three-layered structure had an outer layer of PCCE having a thickness of 0.5 mils, a tie layer (BYNEL® 4206 (DuPont)) having a thickness of 1.0 mil, and an inner layer of a metallocene catalyzed ULDPE (Dow Affinity 1880) having a thickness of 7.5 mil for a total thickness of about 9 mil. This structure was fabricated into a 6 liter container and filled with sterile water and sealed with heat. The container withstood repeated 8 ft drop tests.

It will be understood that the invention may be embodied in other specific forms without departing from the spirit or central characteristics thereof. The present example and embodiments, therefore, are to be considered in all respects as illustrative and not restrictive, and the invention is not to be limited to the details given herein.

1. A multiple-layer structure for fabricating a flexible container or a tank liner or the like comprising:
a first layer of selected from the group consisting of polyesters and polyamides;
a second layer attached to the first layer, the second layer of an ethylene and α-olefin copolymer having a density of less than about 0.900 g/cc ; and
wherein the structure has a modulus of elasticity of less than about 60,000 psi.

2. The structure of claim 1, wherein the polyester is a polyester ether.

3. The structure of claim 2, wherein the polyester ether is obtained from reacting 1,4 cyclohexane dimethanol, 1,4 cyclohexane dicarboxylic acid and polytetramethylene glycol ether.

4. The structure of claim 1, wherein the polyamide results from a ring-opening reaction of lactams having from 4-12 carbons.

5. The structure of claim 1, wherein the polyamide is selected from the group consisting of nylon 6, nylon 10 and nylon 12.

6. The structure of claim 1, wherein the polyamide is selected from the group consisting of aliphatic polyamides resulting from the condensation reaction of di-amines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers.

7. The structure of claim 1, wherein the polyamide is selected from the group consisting of nylon 66, nylon 6,10 and dimer fatty acid polyamides.

8. The structure of claim 1, wherein the α-olefin has from 4 to 8 carbons.

9. The structure of claim 8, wherein the ethylene and a-olefin copolymer is produced using a single-site catalyst.

10. The structure of claim 8, further comprising a tie layer positioned between the first layer and the second layer.

11. The structure of claim 10, wherein the tie layer is a polyolefin polymer or copolymer blended with a polyethylene copolymer grafted with a carboxylic acid anhydride or a carboxylic acid.

12. The structure of claim 11, wherein the carboxylic acid anhydride is an unsaturated fused ring carboxylic acid anhydride.

13. The structure of claim 12, wherein the carboxylic acid anhydride is a maleic anhydride.

14. The structure of claim 10, wherein the first layer is from about 0.5 mils to about 4.0 mils thick, the second layer is from about 4.0 to about 10.0 thick, and the tie layer is from about 0.2 mils to about 1.2 mils thick.

15. The structure of claim 14, wherein the structure is fabricated by a coextrusion process.

16. The structure of claim 15, wherein the coextrusion process is a cast coextrusion process.

17. The structure of claim 16, wherein the cast coextrusion process is carried out essentially free of slip agents.

18. A multiple-layer structure for fabricating a flexible container or a tank liner or the like comprising:
a first layer of a PCCE having a thickness from about 0.5 mils to about mils 4.0 mils;
a second layer attached to the first layer, the second layer of an ethylene and α-olefin copolymer having a density of less than about 0.900 g/cc, the second layer having a thickness from about 4.0 mils to about 12.0 mils ; and
wherein the structure has a modulus of elasticity of less than about 60,000 psi.

19. The structure of claim 18 wherein the α-olefin has from 4 to 8 carbons.

20. The structure of claim 19, wherein the ethylene and α-olefin copolymer is produced using a single-site catalyst.

21. The structure of claim 20, further comprising a tie layer positioned between the first layer and the second layer.

22. The structure of claim 21, wherein the tie layer is a polyolefin polymer or copolymer blended with a polyethylene copolymer grafted with a carboxylic acid anhydride or a carboxylic acid.

23. The structure of claim 22, wherein the carboxylic acid anhydride is an unsaturated fused ring carboxylic acid anhydride.

24. The structure of claim 23, wherein the carboxylic acid anhydride is a maleic anhydride.

25. The structure of claim 21, wherein the first layer is from about 0.5 mils to about 2.0 mils thick, the second layer is from about 6.0 mils to about 10.0 mils thick, and the tie layer is from about 0.2 mils to about 2.0 mils thick.

26. The structure of claim 21, wherein the structure is fabricated by a coextrusion process.

27. The structure of claim 26, wherein the coextrusion process is a cast coextrusion process.

28. The structure of claim 27, wherein the cast coextrusion process is carried out essentially free of slip agents.

29. A multiple-layer structure for fabricating medical products comprising:
a first layer of a PCCE having a thickness from about 0.5 mils to about 4.0 mils;
a second layer of an ethylene and a-olefin copolymer having a density of less than about 0.900 g/cc, the second layer having a thickness from about 4.0 mils to about 12.0 mils;
a tie layer positioned between the first layer and the second layer and connected thereto, the tie layer having a thickness from about 0.5 mils to about 2.0 mils; and
wherein the structure has a modulus of elasticity of less than about 60,000 psi.

30. The structure of claim 29, wherein the α-olefin has from 4 to 8 carbons.

31. The structure of claim 30, wherein the ethylene and α-olefin copolymer is produced using a single-site catalyst.

32. The structure of claim 31, wherein the tie layer is a polyolefin polymer or copolymer blended with a polyethylene copolymer grafted with a carboxylic acid anhydride or a carboxylic acid.

33. The structure of claim 32, wherein the carboxylic acid anhydride is an unsaturated fused ring carboxylic acid anhydride.

34. The structure of claim 33, wherein the carboxylic acid anhydride is a maleic anhydride.

35. The structure of claim 32, wherein the first layer is from about 0.5 mils to about 2.0 mils thick, the second layer is from about 6.0 mils to about 10.0 mils thick, and the tie layer is from about 0.2 mils to about 1.0 mil thick.

36. The structure of claim 32, wherein the structure is fabricated by a coextrusion process.

37. The structure of claim 36, wherein the coextrusion process is a cast coextrusion process.

38. The structure of claim 37, wherein the cast coextrusion process is carried out essentially free of slip agents.

39. A method for fabricating a multilayered structure comprising the steps of:
providing a PCCE material;
providing an ethylene and a-olefin copolymer having a density of less than about 0.900 g/cc;
providing a tie material;
coextruding the PCCE material, the ethylene and α-olefin copolymer and the tie layer to define a multilayered structure having a first layer of PCCE, a second layer of ethylene and α-olefin copolymer and a tie layer attaching the first layer to the second layer; and
wherein the step of coextruding is carried essentially free of slip agents.

40. The method of claim 39, wherein the α-olefin has from 4 to 8 carbons.

41. The method of claim 40, wherein the ethylene and α-olefin copolymer is produced using a single-site catalyst.

42. The method of claim 41, wherein the tie material is a polyolefin polymer or copolymer blended with a polyethylene copolymer grafted with a carboxylic acid anhydride or a carboxylic acid.

43. The method of claim 42, wherein the carboxylic acid anhydride is an unsaturated fused ring carboxylic acid anhydride.

44. The method of claim 43, wherein the carboxylic acid anhydride is a maleic anhydride.

45. The method of claim 42, wherein the first layer is from about 0.5 mils to about 4.0 mils thick, the second layer is from about 4.0 mils to about 12.0 thick, and the tie layer is from about 0.2 mils to about 2.0 mils thick.

46. A multiple-layer structure for fabricating medical products comprising:
a first layer of a polyamide having a thickness from about 0.5 mils to about mils 4.0 mils;
a second layer attached to the first layer, the second layer of an ethylene and α-olefin copolymer having a density of less than about 0.900 g/cc, the second layer having a thickness from about 4.0 mils to about 12.0 mils ; and
wherein the structure has a modulus of elasticity of less than about 60,000 psi.

47. The structure of claim 46, wherein the α-olefin has from 4 to 8 carbons.

48. The structure of claim 47, wherein the ethylene and a-olefin copolymer is produced using a single-site catalyst.

49. The structure of claim 46, further comprising a tie layer positioned between the first layer and the second layer.

50. The structure of claim 49, wherein the tie layer is a polyolefin polymer or copolymer blended with a polyethylene copolymer grafted with a carboxylic acid anhydride or a carboxylic acid.

51. The structure of claim 50, wherein the carboxylic acid anhydride is an unsaturated fused ring carboxylic acid anhydride.

52. The structure of claim 51, wherein the carboxylic acid anhydride is a maleic anhydride.

53. The structure of claim 49, wherein the first layer is from about 0.5 mils to about 2.0 mils thick, the second layer is from about 6.0 mils to about 10.0 mils thick, and the tie layer is from about 0.2 mils to about 2.0 mils thick.

54. The structure of claim 49, wherein the structure is fabricated by a coextrusion process.

55. The structure of claim 54, wherein the coextrusion process is a cast coextrusion process.

56. The structure of claim 55, wherein the cast coextrusion process is carried out essentially free of slip agents.

57. The structure of claim 46, wherein the polyamide results from a ring-opening reaction of lactams having from 4-12 carbons.

58. The structure of claim 46, wherein the polyamide is selected from the group consisting of nylon 6, nylon 10 and nylon 12.

59. The structure of claim 46, wherein the polyamide is selected from the group consisting of aliphatic polyamides resulting from the condensation reaction of diamines having a carbon number within a range of 2-13, aliphatic polyamides resulting from a condensation reaction of di-acids having a carbon number within a range of 2-13, polyamides resulting from the condensation reaction of dimer fatty acids, and amide containing copolymers.

60. The structure of claim 46, wherein the polyamide is selected from the group consisting of nylon 66, nylon 6,10 and dimer fatty acid polyamides.
